(19) United States
(12) Patent Application Publication
(10) Pub. No.: US 2026/0355703 A1
(43) Pub. Date: Nov. 12, 2026

(54) OXYGENATED MATERIALS, SYSTEMS FOR FORMING OXYGENATED MATERIALS, AND ASSOCIATED METHODS

(71) Applicant: Meda-Tron L.L.C., Cottonwood Heights, UT (US)

(72) Inventor: Craig Richard Mellen, Cottonwood Heights, UT (US)

(21) Appl. No.: 19/672,386

(22) Filed: May 8, 2026

Related U.S. Application Data
(60) Provisional application No. 63/803,267, filed on May 9, 2025.

(51) Int. Cl. B01F 23/23; B01F 23/237; B01F 101/40

(52) U.S. Cl. CPC B01F 23/238; B01F 23/237612; B01F 2101/40; B01F 2215/0445

(57) ABSTRACT

Systems and methods for creating an oxygenated material include holding an oil in a chamber, positioning an insulated coil at least partially in the oil, and applying an alternating current voltage between the insulated coil and a conductive structure associated with the chamber. The insulated coil substantially prevents electrical current from passing through the oil while the alternating current voltage induces a changing magnetic field in the oil. The changing magnetic field electrically charges or polarizes molecules of the oil and facilitates attachment of oxygen ions from oxygen-containing molecules to the molecules of the oil. The resulting oxygenated material may include an oil having an oxygen ion concentration greater than about 6 wt%.

### CROSS-REFERENCE TO RELATED APPLICATIONS

This application claims the benefit under 35 U.S.C. § 119(e) of U.S. Provisional Patent Application Serial No. 63/803,267, filed May 9, 2025, the disclosure of which is hereby incorporated herein in its entirety by this reference.

### TECHNICAL FIELD

Embodiments of the present disclosure generally relate to oxygenated materials. In particular, embodiments of the present disclosure relate to antioxidant materials, oxygenated materials, and related systems and methods.

### BACKGROUND

Antioxidants are useful tools for disease prevention and/or treatment. Antioxidants work primarily by neutralizing free radicals (e.g., unstable atoms with unpaired electrons) that can damage cellular components such as DNA, proteins, and membranes. These free radicals are generated both endogenously, as by-products of normal metabolic processes, and exogenously, through exposure to environmental stressors like pollution, radiation, and cigarette smoke.

Under normal physiological conditions, the body maintains a balance between free radicals and antioxidants. However, when this balance is disrupted—either due to increased radical production or insufficient antioxidant defenses—oxidative stress occurs. This condition can lead to a cascade of molecular damage and has been implicated in the development of various diseases.

Antioxidants counteract oxidative stress by donating electrons to free radicals, thereby stabilizing them without becoming reactive themselves. This antioxidant action may help prevent a chain reaction of radical formation and cellular damage. Antioxidants not only protect cellular integrity but also support broader physiological functions such as immune defense and detoxification.

Antioxidant materials may be made even more effective when they are subjected to an oxygenation process wherein they receive a higher concentration of oxygen ions. The resulting oxygenated materials or antioxidant emulsions may have heightened physiological benefits compared to un-oxygenated materials.

### SUMMARY

Embodiments of the disclosure include an oxygenated material. The oxygenated material includes: an oil having an oxygen ion concentration greater than about 6 wt%. The oil further includes molecules of the oil having oxygen ions attached thereto. Another embodiment of the disclosure includes a system for creating an oxygenated material. The system may include a chamber configured to hold an oil. The system further includes a first electrode electrically coupled to a conductive structure that at least partially surrounds the oil. The system also includes a second electrode electrically coupled to a coil at least partially submerged in the oil, the coil including an insulation layer configured to electrically isolate the coil from the oil. The system further includes an alternating current power source electrically coupled to the first electrode and the second electrode. The insulation layer is configured such that no current passes through the oil between the first electrode and the second electrode. The alternating current power source is configured to induce a changing magnetic field in the oil.

Other embodiments of the disclosure include a method of creating an oxygenated material. The method includes disposing an oil in a chamber. The method further includes positioning an insulated coil in the oil. The method also includes providing oxygen-containing molecules in the oil. The method further includes applying an alternating current voltage between the insulated coil and an electrode in contact with the oil while substantially preventing electrical current from passing through the oil. The method also includes inducing a changing magnetic field in the oil with the applied alternating current. The method further includes electrically charging molecules of the oil to cause oxygen ions from the oxygen-containing molecules to be attracted to molecules of the oil to form the oxygenated material.

### BRIEF DESCRIPTION OF THE DRAWINGS

While the specification concludes with claims particularly pointing out and distinctly claiming embodiments of the present disclosure, the advantages of embodiments of the disclosure may be more readily ascertained from the following description of embodiments of the disclosure when read in conjunction with the accompanying drawings in which:

FIG. 1A illustrates an antioxidant neutralization of a free radical molecule 102;

FIG. 1B illustrates an antioxidant neutralization of a free radical molecule 102;

FIG. 2 illustrates an oil oxygenation system in accordance with embodiments of the disclosure;

FIG. 3 illustrates a schematic of an oil oxygenation system in accordance with embodiments of the disclosure;

FIG. 4 illustrates a schematic of an oil oxygenation system in accordance with embodiments of the disclosure;

FIG. 5 illustrates an enlarged view of a portion of the oil oxygenation system of FIG. 4 in accordance with embodiments of the disclosure;

FIG. 6 illustrates a perspective view of an oil oxygenation system in accordance with embodiments of the disclosure; and

FIG. 7 illustrates a method in accordance with embodiments of the disclosure.

### DETAILED DESCRIPTION

The following description provides specific details, such as material compositions, shapes, and sizes, in order to provide a thorough description of embodiments of the disclosure. However, a person of ordinary skill in the art would understand that the embodiments of the disclosure may be practiced without employing these specific details. Indeed, the embodiments of the disclosure may be practiced in conjunction with conventional techniques employed in the industry.

Drawings presented herein are for illustrative purposes only, and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the terms “configured” and “configuration” refer to a size, a shape, a material composition, a material distribution, orientation, and arrangement of at least one feature (e.g., one or more of at least one structure, at least one material, at least one region, at least one device) facilitating use of the at least one feature in a pre-determined way.

As used herein, the term “substantially” in reference to a given parameter means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, relational terms, such as “beneath,” “below,” “lower,” “bottom,” “above,” “upper,” “top,” “front,” “rear,” “left,” “right,” and the like, may be used for ease of description to describe one element’s or feature’s relationship to another element(s) or feature(s) as illustrated in the drawings. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, the term “and/or” means and includes any and all combinations of one or more of the associated listed items.

As used herein, the terms “vertical,” “longitudinal,” “horizontal,” and “lateral” are in reference to a major plane of a structure and are not necessarily defined by earth’s gravitational field. A “horizontal” or “lateral” direction is a direction that is substantially parallel to the major plane of the structure, while a “vertical” or “longitudinal” direction is a direction that is substantially perpendicular to the major plane of the structure. The major plane of the structure is defined by a surface of the structure having a relatively large area compared to other surfaces of the structure.

As used herein, “endothermic” means a chemical or physical process that absorbs heat from its surroundings and generally leads to a decrease in the temperature of those surroundings.

As used herein, “antioxidant material” means and includes a material formulated, configured, or otherwise operable to inhibit, reduce, or prevent oxidation of one or more other materials. The antioxidant material may be configured to react with, consume, scavenge, or otherwise mitigate an oxidizing species. Antioxidant material may broadly encompass antioxidant topical compounds, such as antioxidant oils, antioxidant emulsions, antioxidant powders, antioxidant gels, or other oxygenated compositions.

As used herein, “oxygen ion concentration” may refer to the amount of oxygen ions incorporated into, associated with, or attached to molecules of the associated material, expressed as a weight percentage relative to the total weight of the associated material.

As used herein, “oxygenated material” means and includes an antioxidant material which has obtained a higher oxygen ion concentration.

As discussed above, antioxidant materials may facilitate healing and/or disease prevention. In light of these properties and results, efforts have been made to increase the concentration of oxygen ions in oils that already have natural antioxidant properties to increase the neutralizing effect of the associated oil. Conventionally, ozone (e.g., O₃) is bubbled through the oil or a solution including the oil. Thus, some oxygen ions from the bubbling ozone attach to the oil molecules increasing the oxygen ion concentration in the oil. These processes typically are limited to 1-2 percent by weight (wt%) oxygen ion concentrations. Embodiments of the disclosure include a system configured to produce oxygenated materials, such as coconut oil, olive oil, marine oil, etc., having higher oxygen ion concentrations that may facilitate increased free radical neutralization, which may increase the beneficial effects of the antioxidant properties of the associated oils.

In various embodiments, the oil may include a plant-derived oil, a marine oil, or a blend thereof. For example, the oil may include coconut oil, olive oil, avocado oil, sunflower oil, safflower oil, sesame oil, flaxseed oil, hemp oil, castor oil, soybean oil, palm oil, canola oil, fish oil, cod liver oil, krill oil, algal oil, and mixtures of any of the foregoing. Accordingly, the oxygenated material disclosed herein may include a plant-based oil, a marine oil, or another oxygenated oil composition having oxygen-bearing species associated with molecules of the oil.

The disclosed systems may be operated as batch systems, semi-batch systems, or continuous-flow systems. In batch operation, a defined volume of oil may be treated in the chamber and then removed. In semi-batch or continuous operation, treated material may be removed from a region of the chamber while untreated or less-treated oil is introduced into a region of the chamber so that a treatment zone remains established within the system.

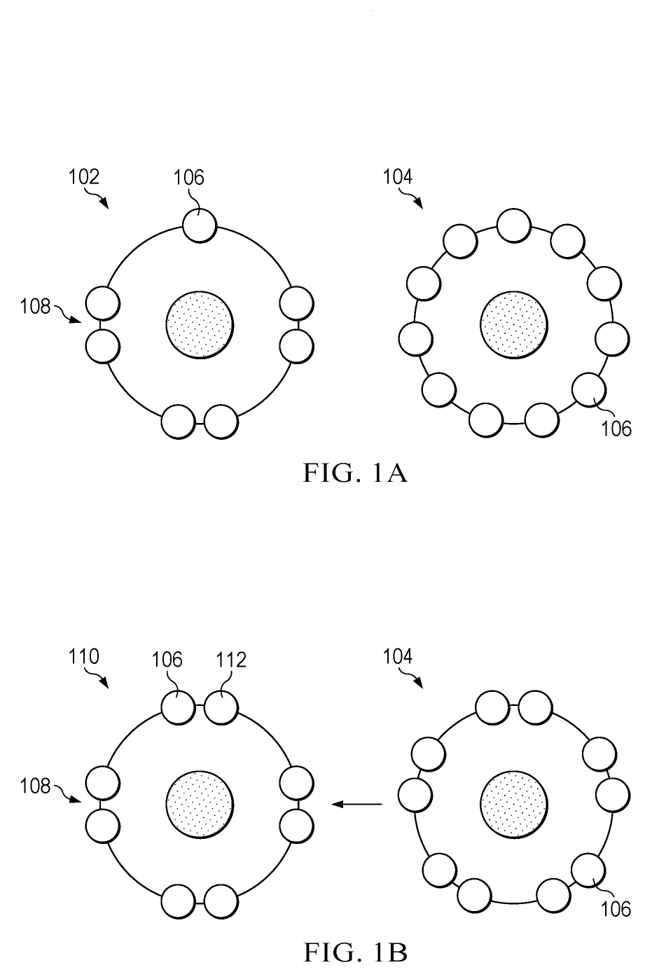

FIGS. 1A and 1B illustrate an antioxidant neutralization of a free radical molecule 102 by an antioxidant molecule 104. As discussed above, a free radical molecule 102 includes an uneven number of electrons 106 and is unstable while an antioxidant molecule 104 includes an uneven number of electrons 106 but remains stable. As illustrated in FIG. 1A, the free radical molecule 102 includes three electron pairs 108 and a single un-paired electron 106. The antioxidant molecule 104 includes eleven unpaired electrons 106 and is stable.

As discussed above, the free radical molecule 102, if left un-neutralized, may pull an electron 106 from another stable molecule creating another free radical molecule. This may create a chain reaction that has been tied to diseases, such as cancer, arthritis, autoimmune disorders, cardiovascular and neurodegenerative diseases. Neutralizing free radical molecules within a body may decrease the spread or even act as treatment for the various diseases linked to free radical chain reactions.

The antioxidant molecule 104 may neutralize the free radical molecule 102 to form a quenched free radical molecule 110 as illustrated in FIG. 1B by donating a transferred electron 112 of one of the eleven electrons 106 to form a fourth electron pair 108 stabilizing the quenched free radical molecule 110. As illustrated in FIG. 1B, the antioxidant molecule 104 remains stable with five electron pairs 108 formed from the remaining ten electrons 106.

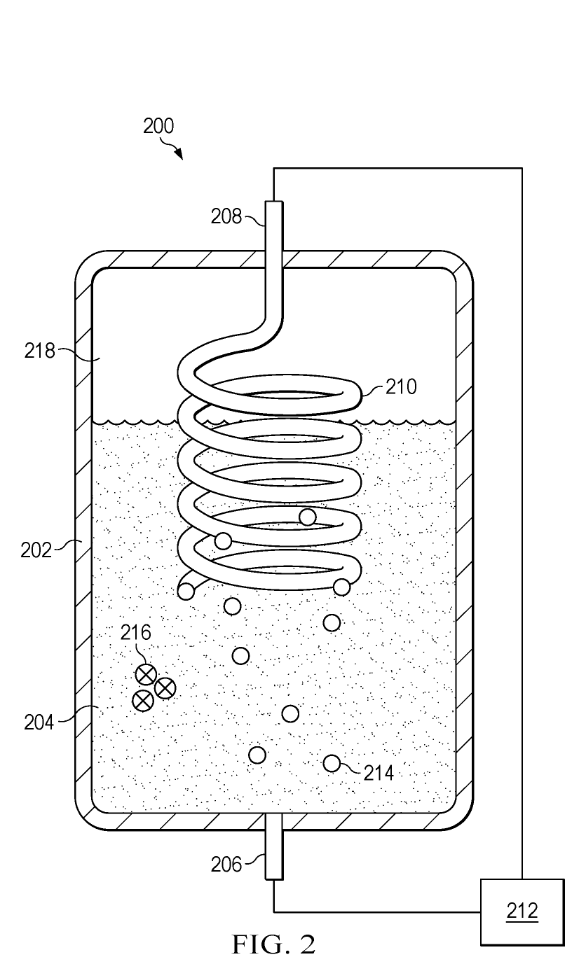

FIG. 2 illustrates a schematic view of an oil oxygenation system 200. The oil oxygenation system 200 includes a chamber 202 configured to hold an oil 204. Two electrodes 206, 208 are connected to a power source 212, such as an alternating current (AC) power source. The power source 212 may be line voltage, a transformer connected to line voltage, etc. The first electrode 206 is connected to a lower wall of the chamber 202. The second electrode 208 is connected to a coil 210 positioned and configured to be suspended in the oil 204.

In some embodiments, the chamber 202 includes a conductive metal vessel, conductive liner, or conductive shell that forms at least a portion of the first electrical pole. The first electrode 206 may be coupled directly to a bottom wall, side wall, or conductive base of the chamber 202, while the second electrode 208 may be coupled to a lead that suspends the coil 210 from an upper region of chamber 202. The coil 210 may be helical, spiral, serpentine, or otherwise curved to extend through a treatment volume of the oil 204. The conductor of the coil 210 may be covered by a dielectric insulation layer, sleeve, coating, or jacket configured to electrically isolate the conductor from direct contact with oil 204.

The power source is configured to apply a relatively high voltage across the electrodes 206, 208. The relatively high voltage may be in a range from about 10,000 VAC to about 30,000 VAC, such as from about 15,000 VAC to about 20,000 VAC or from about 12,000 VAC to about 15,000 VAC. The coil 210 may be insulated to voltages greater than the relatively high voltage of the power source 212. The relatively high voltage applied across the electrodes 206, 208 is prevented from inducing a current through the oil 204 between the lower wall of the chamber 202 and the coil 210 suspended in the oil 204 by the insulation on the coil 210. Because no current passes through the oil 204, the process is substantially endothermic, such that a temperature of the oil 204 remains substantially the same or even lowers during the process. The temperature of the oil 204 does not rise to a temperature approaching an ignition temperature of the oil 204. The relatively large voltage between the electrodes 206, 208 is constantly changing polarity due to the alternating current. Thus, the voltage may create constantly changing magnetic fields in the oil 204 between the walls of the chamber 202 and the coil 210 that may induce charges in the individual molecules in the oil 204.

In some embodiments, the power source 212 provides a sinusoidal alternating current, line-frequency alternating current, transformed line voltage, or another periodically varying potential difference sufficient to establish the changing magnetic field while substantially preventing current conduction through the oil 204. The oil oxygenation system 200 may operate in a non-discharge regime in which the oil 204 is subjected to a changing electromagnetic environment without arcing through the bulk of the oil 204.

The induced charges may cause oxygen ions 216 suspended in the oil 204 to be attracted and attach to the charged molecules in the oil 204 increasing the oxygen ion concentration of the oil 204. In some embodiments, the oxygen ion 216 comes from oxygen 214 that is already suspended in the oil 204. In other embodiments, the oxygen ions 216 are pulled from oxygen 214 in an open cavity 218 of the chamber 202 above the oil 204 or from the atmosphere. In other embodiments, oxygen 214 or ozone is supplied to the oil 204 in the chamber 202 through a diffuser, sparger, or porous stone, forming bubbles in the oil 204 that may then release oxygen ions 216 that are attached to the charged molecules in the oil 204.

The changing magnetic fields in the oil 204 induced by the high voltage alternating current power source 212 may generate movement of the individual molecules in the oil 204, inducing a churning or stirring motion in the oil 204. In some embodiments, the churning or stirring motion produced by the changing field promotes circulation of the oil 204 around the coil 210 and between the coil 210 and the chamber 202. The resulting oxygenated material may include an antioxidant emulsion in which oxygen-bearing species are associated with molecules of the oil while the oil remains suitable for topical administration. In some embodiments, treatment may continue until the oxygenated material exhibits an oxygen ion concentration greater than about 6 wt%.

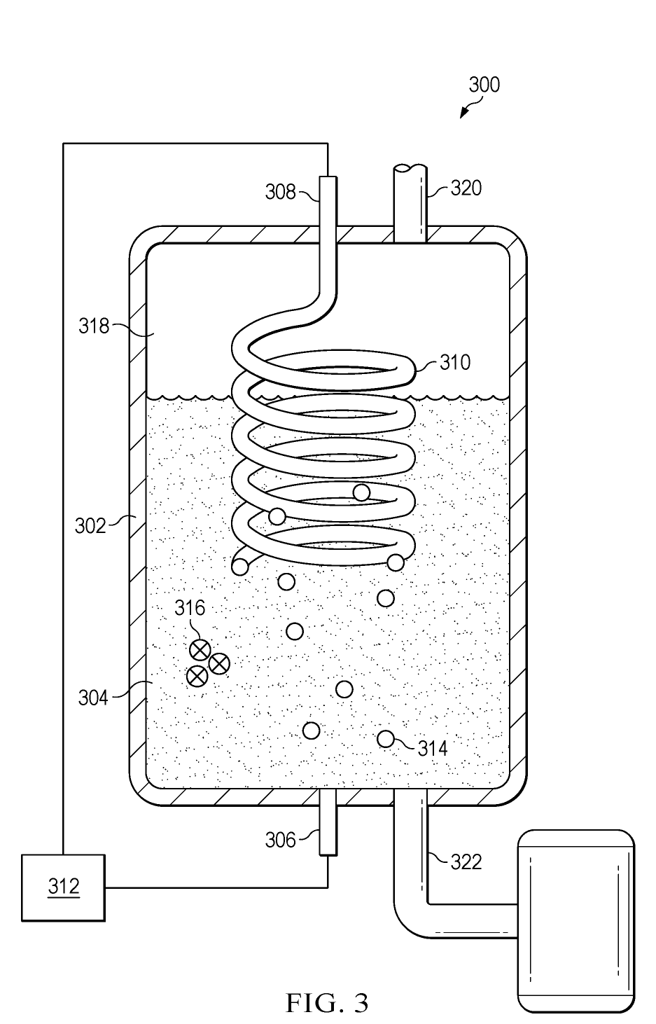

FIG. 3 illustrates a schematic view of an oil oxygenation system 300. The oil oxygenation system 300 includes a chamber 302 configured to hold an oil 304. Two electrodes 306, 308 are connected to a power source, such as an alternating current (AC) power source. The power source 314 may be line voltage, a transformer connected to line voltage, etc. A first electrode 306 is connected to a wall of the chamber 302. A second electrode 308 is connected to a coil 310 positioned and configured to be suspended in the oil 304.

In the embodiment of FIG. 3, chamber 302 includes an inlet 320 through which untreated or less oxygenated oil may be introduced and an outlet 322 through which oxygenated material may be withdrawn from a lower region of the chamber. The outlet 322 may communicate with a valve, pump, receiving vessel, transfer line, or recirculation loop so that product can be removed intermittently or continuously. In some embodiments, introduction of oil through the upper region and withdrawal of oxygenated material from the lower region maintains a substantially constant liquid level in chamber 302 during treatment.

In some embodiments, the power source 312 provides a sinusoidal alternating current, line-frequency alternating current, transformed line voltage, or another periodically varying potential difference sufficient to establish the changing magnetic field while substantially preventing current conduction through the oil 304. The oil oxygenation system 300 may operate in a non-discharge regime in which the oil 304 is subjected to a changing electromagnetic environment without arcing through the bulk of the oil 304.

The induced charges may cause oxygen ions 316 suspended in the oil 304 to be attracted and attach to the charged molecules in the oil 304 increasing the oxygen ion concentration of the oil 304. In some embodiments, the individual oil molecules may combine with the oxygen ions 316 to create an oxygenated material from the oil 304 and oxygen ions 316. In other embodiments, the oxygen ions 316 are pulled from oxygen 314 in an open cavity 318 of the chamber 302 above the oil 304 or from the atmosphere. As the oxygenated material is created, it may move towards the bottom of the chamber 302, such as due to the oxygenated material having a greater density than the oil 304. The oxygenated material may be drawn out of the lower region of the chamber through the outlet 322. In some embodiments, oil is admitted into the chamber through the inlet 320 as oxygenated material is removed from the chamber through the outlet 322.

In some embodiments, the oxygenated material withdrawn from the lower region includes oil that has experienced a longer residence time within the treatment zone than oil newly introduced through the upper region. Gravity-driven settling, circulation induced by bubbling gas, the density of the oxygenated material and/or circulation induced by the changing magnetic field may all contribute to movement of oxygenated material toward the lower region. The embodiment of FIG. 3 may facilitate semi-batch and continuous formation of oxygenated material using the same electrically insulated coil architecture described above with respect to FIG. 2.

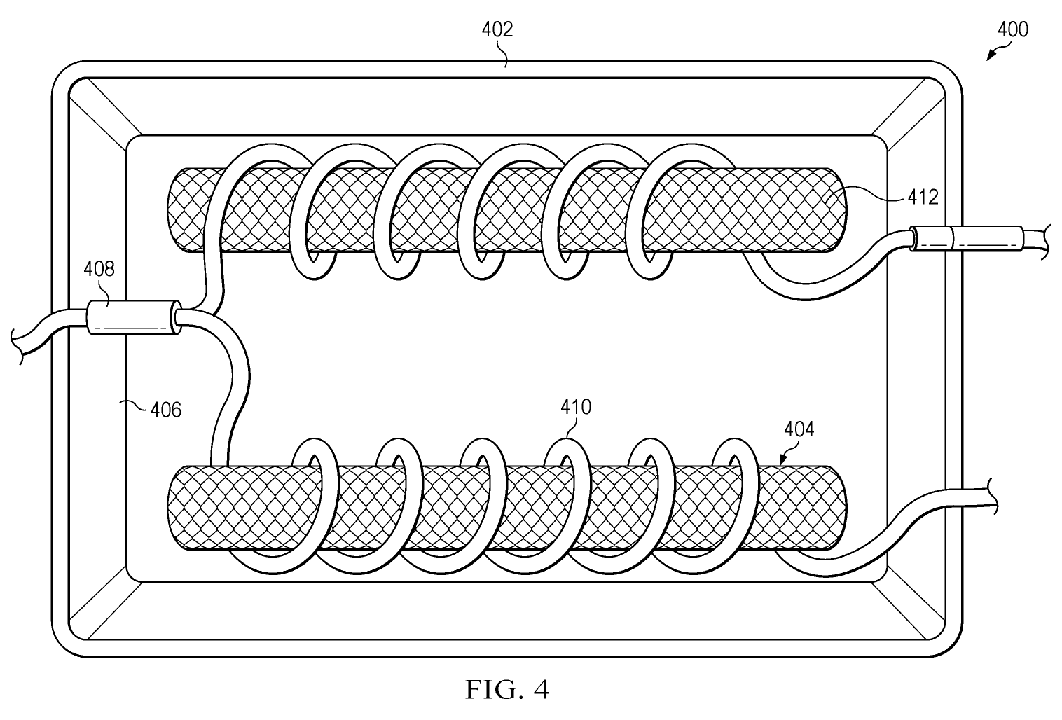

FIG. 4 illustrates a perspective view of an embodiment of an oil oxygenation system 400 in accordance with embodiments of the disclosure. The oil oxygenation system 400 includes a chamber 402 configured to contain oil. The chamber 402 is electrically configured to form a first electrode 406 at least partially surrounding the oil. For example, the walls of the chamber may be electrically connected to a power source. A second electrode 408 is connected to one or more coils 410 which are positioned and configured to be suspended in the oil within the chamber 402.

FIG. 4 illustrates that chamber 402 may receive a plurality of spacers 404 configured to arrange the loops of the coils 410 along the chamber. The spacers 404 may include, for example, elongated treatment members, cartridges, tubes, sleeves, or insulating cores extending through the chamber. In some embodiments, each spacer 404 includes a respective coil 410 so that a larger treatment volume may be established within a compact chamber footprint. The second electrode 408 may be electrically coupled to each of the coils 410 in parallel or in series, and the coils 410 may be spaced from one another and from the chamber 402 so that the oil can circulate around and between the coils 410. Alternatively, the coils 410 may reside within the chambers 402 without any spacers 404.

As illustrated in FIG. 4, the coils 410 include insulation 412 over the coils 410 configured to electrically isolate the coils 410 from the oil. The insulation 412 may be configured to prevent electrical current at voltages greater than the voltage of the power supply, such that no current passes through the oil between the chamber 402 and the coils 410. As discussed above, the alternating current operating at relatively high voltages may induce changing magnetic fields in the oil. The changing magnetic fields may induce charges on the individual molecules of the oil that may attract oxygen ions disposed in the oil, such as oxygen ions from the atmosphere, oxygen ions from oxygen or ozone injected into the oil, or oxygen ions that are already present in the oil.

In some embodiments, the chamber 402 is electrically configured to form a first electrode 406, while in other embodiments the first electrode 406 includes a conductive insert, liner, plate, or wall portion electrically coupled to the chamber 402. The insulation 412 may include a polymer coating, shrink sleeve, molded jacket, glass coating, ceramic coating, or another dielectric barrier configured to withstand a voltage greater than the voltage applied by the power supply. The use of multiple insulated coils 410 may increase throughput, improve uniformity of treatment, and provide redundancy if one of the insulated coils 410 is removed for cleaning or replacement.

The charged molecules may result in increased oxygen ion concentration in the oil. For example, the oil may have an oxygen ion concentration greater than about 3 percent by weight (wt%), such as greater than about 5wt%, or greater than about 6wt%. The increased oxygen ion concentration without increased reactivity may result in creating an oxygenated material with increased antioxidant properties. For example, the oxygenated material may have a higher rate of neutralization of free radicals.

The oxygenated material may be used to treat illnesses or prevent illnesses in patients. Oils are fat soluble which facilitates their absorption into the body, such as through the skin when applied topically. Thus, the oxygenated material including the additional oxygen ions may be absorbed into the body, where the molecules of oil with the additional oxygen ions may be transferred into the blood stream or lymph system. For example, the oxygenated material may be applied topically to a patient in proximity to lymph nodes, such that the molecules including the extra oxygen ions may be absorbed into the lymph system and may neutralize free radicals in the patient’s body that are being filtered through the lymph system reducing oxidative stresses in the body. The increase of oxygen ions in the lymph system may increase the body’s immune system defenses and aid the immune system in addressing different ailments tied to free radical multiplication, such as cancer, arthritis, autoimmune disorders, cardiovascular and neurodegenerative diseases. The increased oxygen ion concentrations in the oxygenated material may increase the number of free radicals neutralized by the oxygenated material facilitating faster treatment and improved health.

In some embodiments, the oxygenated material formed in the chamber 402 may be collected for subsequent packaging, storage, topical application, transdermal use, or incorporation into another formulation. For example, the oxygenated material may be incorporated into a balm, lotion, gel, ointment, salve, carrier oil blend, or other pharmaceutically or cosmetically acceptable composition while retaining oxygen-bearing species associated with molecules of the treated oil.

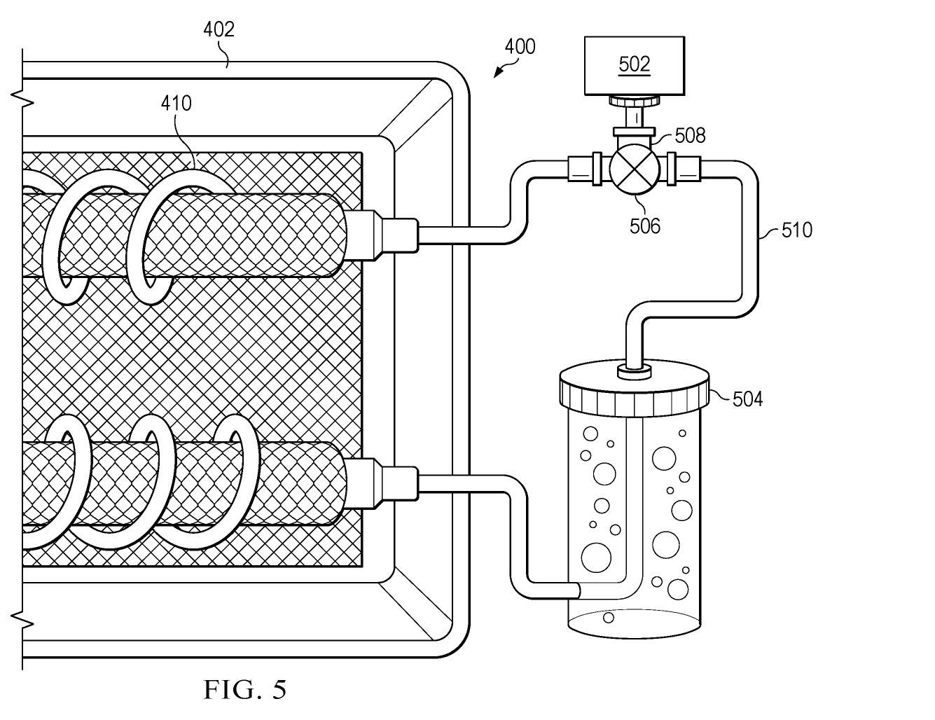

FIG. 5 illustrates a perspective view of an embodiment of the oil oxygenation system 400 in accordance with embodiments of the disclosure.

In the embodiment of FIG. 5, the oil oxygenation system 400 includes a gas source 502, pump 504, regulator 506, valve assembly 508, and/or conduit arrangement 510 for supplying oxygen-containing gas to the chamber 402 during electrical treatment. The gas source 502 may include an oxygen cylinder, ozone generator, air pump, oxygen concentrator, or another device configured to deliver oxygen, ozone, ambient air, oxygen-enriched gas, or mixtures thereof. The gas may be delivered to one or more diffusers, porous stones, frits, spargers, perforated tubes, or gas-permeable members positioned within the oil so that bubbles pass through the treatment volume adjacent the insulated coils 410.

Flow of the oxygen-containing gas may be continuous, pulsed, metered, or feedback-controlled. In some embodiments, the gas is introduced near a lower region of the chamber so that bubbles rise through the oil and increase residence time of the gas within the treatment volume. Introducing the oxygen-containing gas into the oil may further increase the oxygen ions interacting with the oil, which may further increase the oxygen ion concentration of the oxygenated material produced by the oil oxygenation system 400.

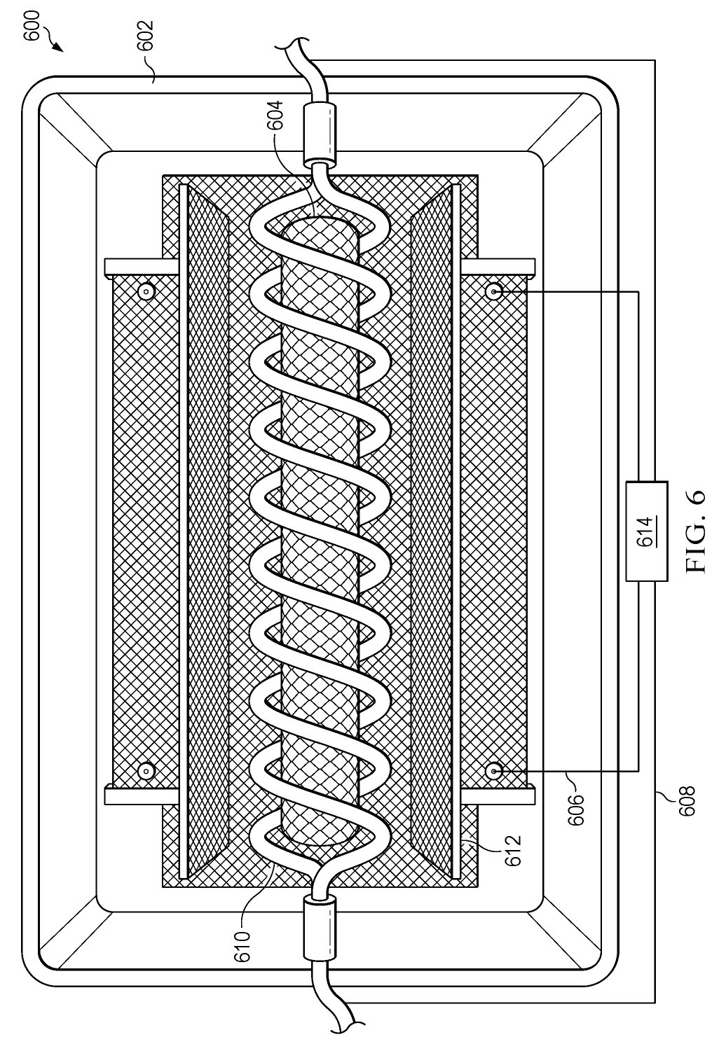

FIG. 6 illustrates a perspective view of an embodiment of an oil oxygenation system 600 in accordance with embodiments of the disclosure. The oil oxygenation system 600 includes a chamber 602 configured to contain oil. The chamber contains one or more coils 610 housed at least partially within a perforated conductive structure 612. A first electrode 606 may be created by electrically coupling a power source 614 to the perforated conductive structure 612, and a second electrode 608 is connected to one or more coils 610 which are positioned and configured to be at least partially submerged in the oil within the chamber 402.

In the embodiment of FIG. 6, the perforated conductive structure 612 may include a mesh cage, screen, expanded-metal member, perforated plate, slotted plate, conductive basket, or other conductive structure electrically coupled to the power source 614. In some embodiments, the perforated conductive structure may include a cylindrical cage, a half-cage, opposed perforated plates, a mesh sleeve, or a multi-sided enclosure surrounding one or more coils 610. The conductive structure may be removable for cleaning, replacement, or reconfiguration to accommodate different batch sizes or flow rates. The perforated conductive structure 612 may extend laterally, above, below, or fully around the insulated coil 610 so that the coil 610 is at least partially surrounded by the perforated conductive structure 612 while oil remains free to move through openings in the perforated conductive structure. In some embodiments, the perforated conductive structure 612 is a separate component attached to the chamber 602, and in other embodiments it is electrically common with the chamber 602.

The second electrode 608 is electrically coupled to the one or more coils 610. As discussed above, an alternating current operating at relatively high voltages may induce changing magnetic fields in the oil which may result in increased antioxidant properties of the oil. Also as discussed above, the charged molecules may result in increased oxygen ion concentration in the oil (e.g., the oil), where the oil may have an oxygen ion concentration greater than about 3 percent by weight (wt%), such as greater than about 5wt%, or greater than about 6wt%. The chamber 602 may also receive a plurality of spacers 604 configured to arrange the loops of the one or more coils 610 along the chamber 602 and at least partially within the perforated conductive structure 612. The perforated conductive structure 612 may be configured to increase a surface area of the first electrode 606 in contact with the oil. The increased surface area may further increase the charges induced on the oil molecules, which may increase the number of oxygen ions attached to the oil molecules. This may result in a greater oxygen ion concentration in the oxygenated oil after being processed in the oil oxygenation system 600.

When the insulated coil 610 is electrically coupled to the second electrode 608 of the alternating current power source 614 and the perforated conductive structure 612 is electrically coupled to a first electrode 606 of the alternating current power source, the relative polarity between the coil 610 and perforated conductive structure 612 alternates during operation. The perforated conductive structure may shape the field distribution around the coil 610, localize a treatment region, and provide a conductive structure that at least partially surrounds the oil and/or the coil without permitting bulk current to pass through the oil. In some embodiments, the perforated conductive structure is spaced from the insulated coil 610 by a substantially uniform gap. In other embodiments, such as the embodiment illustrated in FIG. 6, the gap between the insulated coil 610 and the perforated conductive structure 612 varies. For example, in the embodiment illustrated in FIG. 6, the insulated coil 610 forms a helix with a circular cross-sectional shape while the perforated conductive structure 612 forms a rectangular cylinder. Thus, the distances between the insulated coil 610 and the perforated conductive structure 612 vary from the corners of the perforated conductive structure 612 where the distance between the insulated coil 610 and the perforated conductive structure 612 is the greatest to a central region of side plates of the perforated conductive structure 612 where the distance between the insulated coil 610 and the perforated conductive structure 612 is the smallest.

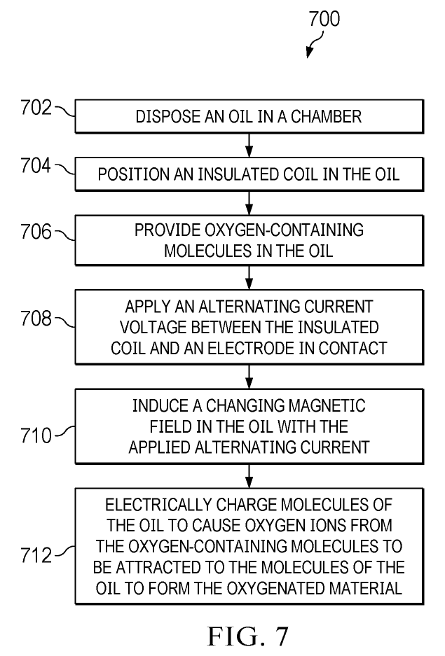

FIG. 7 illustrates a method 700 of creating an oxygenated material. In act 702, an oil is disposed into a chamber, such as the chambers 302, 402, 602 (FIGS. 3-6). As discussed above, the oil may be a plant-based oil, a marine oil, or another oxygenated oil composition having oxygen-bearing species associated with molecules of the oil. As discussed above, the oil may be disposed into the chamber in a single action or in a continuous or semi-continuous flow.

In act 704, an insulated coil, such as insulated coils 310, 410, 610 (FIGS. 3-6) is disposed in the oil. In some embodiments, the insulated coil is fully disposed in the oil. In other embodiments, the insulated coil may be partially disposed (e.g., a portion of the insulated coil may not be covered by the oil). For example, at least 50% of the insulated coil may be disposed in the oil, such as from about 50% to about 100% of the insulated coil or from about 75% to about 100% of the insulated coil. In some embodiments, the insulated coil is a helical coil. In other embodiments, the insulated coil may be arranged as a flat spiral coil, a planar coil, a solenoidal coil, a toroidal coil, a conical coil, a pancake coil, a basket-wound coil, a honeycomb-wound coil, a bifilar coil, a multifilar coil, a single-layer coil, a multi-layer coil, a saddle coil, a rectangular coil, a square coil, an oval coil, a serpentine coil, a meander coil, or combinations thereof. In some embodiments, the insulated coil is loosely disposed in the oil. In other embodiments, the insulated coil may be secured to another structure. For example, the insulated coil may be suspended from an upper portion of the chamber, mounted to a support, or coupled to a removable treatment cartridge.

In act 706, the oxygen-containing molecules may be supplied from one or more of oxygen already dissolved in the oil, oxygen present in a headspace adjacent the oil, ambient atmosphere in fluid communication with the chamber, or oxygen or ozone bubbled through the oil. The oxygen-containing molecules may include molecular oxygen, ozone, oxygen-bearing radicals, oxygen-bearing ions, dissolved oxygen species, or combinations thereof. In some embodiments, oxygen or ozone is introduced through a diffuser, porous stone, frit, sparger, perforated tube, or other gas-distribution member to increase the surface area of gas exposed to the oil. In other embodiments, the oxygen-containing molecules may be present in the oil before treatment, and the applied alternating current field may facilitate interaction between the pre-existing oxygen-containing molecules and molecules of the oil. The oxygen-containing molecules may be provided continuously, intermittently, or before application of the alternating current voltage.

In act 708, the alternating current voltage may be greater than about 10,000 VAC, from about 10,000 VAC to about 30,000 VAC, from about 12,000 VAC to about 15,000 VAC, or from about 15,000 VAC to about 20,000 VAC. Act 708 may be performed while substantially preventing electrical current from passing through the oil by maintaining a dielectric barrier between the conductor of the coil and the oil. For example, the conductor of the coil may be covered by an insulation layer, coating, sleeve, jacket, or other dielectric material configured to withstand a voltage greater than the voltage applied by the power source. As a result, the oil may be exposed to a changing electromagnetic field without substantial resistive heating, arcing, or bulk current flow through the oil.

In act 710, a changing magnetic field in the oil is induced by the applied alternating current. Without being bound by any particular theory, the insulated coil may operate as an inductor when the alternating current power source applies a time-varying voltage to the coil. As current and voltage through the conductor of the coil vary with time, a corresponding time-varying magnetic field may be generated around the coil. Because the current supplied by the power source alternates polarity, the magnetic field generated around the coil may repeatedly change magnitude and direction during operation. The changing magnetic field may extend into the oil surrounding the insulated coil and may interact with molecules of the oil and oxygen-containing molecules present in the oil. In some embodiments, the conductive chamber wall, conductive vessel, conductive structure, or perforated conductive structure coupled to the opposing electrode may shape or concentrate the changing field within a treatment region between the insulated coil and the conductive structure. Act 710 may induce churning, stirring, circulation, molecular movement, or localized mixing of the oil.

In act 712, the molecules of the oil are electrically charged. Electrically charging the molecules of the oil may cause oxygen ions from the oxygen-containing molecules to be attracted to the molecules of the oil to form the oxygenated material. In act 712, the process may form an oxygenated material having an oxygen ion concentration greater than about 3 wt%, greater than about 5 wt%, greater than about 6 wt%, or more. In act 712, the molecules of the oil are electrically charged, polarized, or otherwise influenced by the changing electromagnetic field. Without being bound by any particular theory, molecules of the oil may include polarizable bonds, electron-rich regions, unsaturated carbon-carbon bonds, ester groups, fatty-acid chains, or other sites capable of interacting with oxygen-containing species. The changing magnetic field and associated electric field may cause temporary charge separation, dipole formation, or localized polarization within molecules of the oil. Oxygen-containing molecules or oxygen-bearing species present in the oil may likewise be polarized, ionized, partially ionized, or otherwise made more reactive or more readily attracted to charged or polarized regions of the oil molecules. The electrical charging or polarization of the oil molecules may therefore increase attraction between oxygen-bearing species and the oil molecules and may facilitate association, bonding, complexing, attachment, or other incorporation of oxygen ions or oxygen-bearing species with molecules of the oil to form the oxygenated material. The churning, stirring, or circulation caused by the changing field may further increase contact between oxygen-containing molecules and charged or polarized oil molecules.

In some embodiments, method 700 further includes withdrawing oxygenated material from a lower region of the chamber and introducing untreated or less-treated oil into an upper region of the chamber. Such withdrawal and replenishment may be carried out intermittently, continuously, or semi-continuously while the alternating current voltage is applied so that the chamber operates as a continuous or semi-batch treatment reactor.

Embodiments of the disclosure may facilitate formation of oxygenated materials having oxygen ion concentrations greater than those achievable using conventional bubbling-only techniques. Embodiments of the disclosure may increase interaction between oil molecules and oxygen-containing molecules while substantially preventing electrical current from passing through the oil. Such operation may reduce heating, reduce ignition risk, limit thermal degradation of the oil, and allow oxygenation to occur while the treatment process remains substantially endothermic. The resulting oxygenated material may exhibit increased antioxidant activity, increased free-radical neutralization capacity, or improved suitability for topical, transdermal, cosmetic, therapeutic, or other applications. The embodiments of the disclosure may also provide manufacturing advantages, including batch, semi-batch, or continuous processing, and/or increased treatment uniformity.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the present disclosure, in addition to those shown and described herein, such as alternative useful combinations of the elements described, may become apparent to those skilled in the art from the description. Such modifications and embodiments are also intended to fall within the scope of the appended claims and their legal equivalents.

What is claimed is:

1. An oxygenated material comprising: an oil having an oxygen ion concentration greater than about 6 wt%, the oil comprising molecules of the oil having oxygen ions attached thereto.

2. The oxygenated material of claim 1, wherein the oil comprises plant-based oil.

3. The oxygenated material of claim 1, wherein the oil comprises marine oil.

4. A system for creating an oxygenated material, the system comprising:
a chamber configured to hold an oil;
a first electrode electrically coupled to a conductive structure that at least partially surrounds the oil;
a second electrode electrically coupled to a coil at least partially submerged in the oil, the coil including an insulation layer configured to electrically isolate the coil from the oil;
an alternating current power source electrically coupled to the first electrode and the second electrode;
wherein the insulation layer is configured such that no current passes through the oil between the first electrode and the second electrode; and
wherein the alternating current power source is configured to induce a changing magnetic field in the oil.

5. The system of claim 4, wherein the insulation layer is configured to withstand a voltage greater than a voltage applied by the alternating current power source.

6. The system of claim 4, wherein the alternating current power source is configured to apply from about 10,000 VAC to about 30,000 VAC.

7. The system of claim 4, further comprising a diffuser, a sparger, or a porous stone configured to introduce oxygen or ozone into the oil.

8. The system of claim 4, wherein the system comprises a plurality of coils extending through the chamber.

9. The system of claim 4, wherein the chamber comprises a conductive metal vessel forming the first electrode.

10. The system of claim 4, wherein the system is configured such that treatment of the oil is substantially endothermic.

11. The system of claim 4, wherein the second electrode is coupled to an upper portion of the chamber and is configured to suspend the coil in the oil.

12. The system of claim 4, wherein the first electrode is electrically coupled to a perforated conductive structure at least partially surrounding the coil.

13. The system of claim 12, wherein the alternating current power source alternates polarity between the coil and the perforated conductive structure.

14. A method of creating an oxygenated material, the method comprising:
disposing an oil in a chamber; positioning an insulated coil in the oil;
providing oxygen-containing molecules in the oil;
applying an alternating current voltage between the insulated coil and an electrode in contact with the oil while substantially preventing electrical current from passing through the oil;
inducing a changing magnetic field in the oil with the applied alternating current; and
electrically charging molecules of the oil to cause oxygen ions from the oxygen-containing molecules to be attracted to the molecules of the oil to form the oxygenated material.

15. The method of claim 14, wherein providing oxygen-containing molecules in the oil comprises using oxygen already suspended in the oil.

16. The method of claim 14, wherein providing oxygen-containing molecules in the oil comprises drawing oxygen from a space adjacent to the oil.

17. The method of claim 14, wherein providing oxygen-containing molecules in the oil comprises bubbling oxygen or ozone through the oil.

18. The method of claim 14, wherein applying the alternating current voltage comprises applying from about 10,000 VAC to about 30,000 VAC.

19. The method of claim 14, wherein the oxygenated material has an oxygen ion concentration greater than about 6 wt%.

20. The method of claim 14, further comprising withdrawing the oxygenated material from a lower region of the chamber and disposing the oil into an upper region of the chamber.
